(19) United States
(12) Patent Application Publication
(10) Pub. No.: US 2018/0283287 A1
(43) Pub. Date: Oct. 4, 2018

(54) ULTRA-LOW NOX EMISSION GAS TURBINE ENGINE IN MECHANICAL DRIVE APPLICATIONS

(71) Applicant: NUOVO PIGNONE TECNOLOGIE SRL, Florence (IT)

(72) Inventors: Andrea MOSSI, Florence (IT); Giampaolo GABBI, Scarperia e Sanpiero (IT); Riccardo CECCHINI, Cypress, TX (US); Ever Avriel FADLUN, Prato (IT)

(21) Appl. No.: 15/570,599

(22) PCT Filed: Apr. 28, 2016
(86) PCT No.: PCT/EP2016/059563

§ 371 Date: Oct. 30, 2017

(30) Foreign Application Priority Data
Apr. 30, 2015 (IT) FI2015A000128

(51) Int. Cl. F02C 9/46; F02C 9/20; F23R 3/46; F23R 3/28; F23R 3/34; F23R 3/14

(52) U.S. Cl. CPC F02C 9/46; F02C 9/20; F23R 3/46; F23R 3/286; F23R 3/346; F01D 9/023; F05D 2270/082; F05D 2270/091; F05D 2270/303; F05D 2270/304; F23R 3/14

(57) ABSTRACT

A gas turbine drive system in mechanical drive configuration is described. The gas turbine drive system comprises a gas turbine engine drivingly connected to a driven turbomachine. The gas turbine engine includes a dry low NOx emission combustor. A gas turbine controller is further provided. The gas turbine controller is arranged and configured for regulating the combustion temperature according to at least one control parameters of the turbomachine so that a lean blowout of the combustor is prevented when a transient event involving the driven turbomachine occurs.

### FIELD OF THE INVENTION

The present disclosure relates to gas turbine engines in mechanical drive applications. Some embodiments disclosed herein concern single-shaft or multi-shaft gas turbine engines driving a load including one or more driven turbomachines, such as compressors or centrifugal pumps. Other embodiments may concern multi-shaft gas turbine engines driving a turbomachine or turbomachine train.

### BACKGROUND OF THE INVENTION

Gas turbine engines are widely used to power electrical generators or rotating equipment, in particular turbomachines, such as centrifugal compressors or pumps. The first kind of application is usually referred to as “power generation application”, while the second configuration is generally referred to as “mechanical drive application”. Mixed configurations are possible when a mechanical drive train is equipped with an reversible electric machine that can work in both as an electric motor, in a so-called helper mode, and as an electric generator, in a so-called generator mode.

The main applications of gas turbine engines in mechanical drive configurations are typically in the field of the liquefied natural gas market, known as LNG. Natural gas is pressurized and liquefied to reduce the volume thereof at the gas field for transportation purposes. Refrigeration cycles using fluid refrigerants are used for this purpose. The refrigerant fluid is compressed by centrifugal compressors driven by gas turbine engines.

Natural gas prices and the discovery of new gas fields create new scenarios for LNG plants. LNG sites are not located in remote areas anymore. Often the LNG installation is located in countries where stricter regulations on emission compliance exist. It becomes thus desirable to reduce the emissions of nitrogen oxides (shortly NOx) in the combustor of gas turbine engines in mechanical drive applications.

Noxious NOx emissions can be reduced e.g. by controlling the combustion temperature in the combustion chamber. Some known emission-reducing techniques provide for water injection in the combustion chamber to reduce NOx emission. In some cases, however, water consumption is not desirable, or no sufficient water is available. Selective catalytic reduction systems (SCR systems) have also been developed, wherein NOx molecules react with ammonia (NH₃) and oxygen, resulting in nitrogen (N2) and water (H₂O) molecules. These systems are complex and expensive. Additionally, their operation requires large amounts of ammonia.

Dry, low NOx emission systems (so-called DLN systems) have thus been developed, which do not require water or ammonia, and which are mainly aimed at controlling the combustion temperature by using lean air/fuel mixtures, i.e. mixtures with a low amount of fuel, such that NOx emissions are reduced. Known dry low NOx (DLN) emission systems are currently used in power generation applications. These applications are characterized by a substantially constant, or negligibly speed variations of the power turbine shaft. As a matter of fact, the electric generator driven by the gas turbine engine rotates theoretically at a constant speed, determined by the frequency of the electric power distribution grid, whereto the electric generator is connected. The turbine shaft is mechanically coupled, either directly or through a gearbox, to the shaft of the electric generator, such that also the gas turbine shaft rotates at a substantially constant rotation speed.

Gas combustors for dry low NOx emission systems have been developed, wherein primary and secondary fuel nozzles are selectively provided with controlled fuel flow rates to minimize noxious gas emissions. Combustors for DLN applications and methods of control are disclosed in U.S. Pat. No. 8,156,743, U.S. Pat. No. 8,020,385, US 2010/0018211, US2011/0247340, US2010/0162711, US2010/0205970, US2011/0131998, the content whereof is incorporated herein by reference. Methods for controlling a gas turbine engine driving an electric generator are disclosed in U.S. Pat. No. 7,100,357, the content whereof is incorporated herein by reference. U.S. Pat. No. 8,474,268 discloses a method of mitigating undesired gas turbine transient response using event based actions in electric generation applications. Further methods and devices for controlling gas turbine engines in electric power generator systems are disclosed in US2013/0219910, US2013/0019607, US2013/0042624, US2012/0279230.

In mechanical drive applications, the load which is coupled to the turbine shaft controls the rotation speed of the gas turbine engine. The rotation speed of the load is in turn controlled by the process, whereof the turbomachine forms part.

The load can comprise one or more rotating turbomachines, the rotation speed whereof can vary e.g. depending upon the requests from the process. For instance, if the load comprises a gas compressor, the rotation speed of the gas compressor can be dependent upon the required gas flowrate through the compressor. In LNG applications, the flowrate of a refrigerant gas through the refrigerant compressor driven by the gas turbine engine can fluctuate depending upon the needs of the refrigeration cycle, for instance depending upon the flow rate of natural gas to be liquefied.

The turbomachine(s) driven by the gas turbine engine may also experience load variations, i.e. the resistive torque on the turbomachine shaft can vary during time, again depending upon operative conditions of the process.

Load and/or speed transients in mechanical drive applications of this kind can amount to several percentage points of the design point condition. Additionally, transients are rather fast.

These factors may prejudice the operation of a gas turbine engine using a DLN system and operating under lean mixture conditions and may lead to instability of the combustion process or even to undesired flame extinction in the combustor chamber.

The need exits, therefore, for an improved low-emission gas turbine system for mechanical drive applications.

### SUMMARY OF THE INVENTION

According to embodiments disclosed herein, a gas turbine drive system in mechanical drive configuration is provided, comprising: a gas turbine engine drivingly connected to a driven turbomachine, the gas turbine engine including a dry low NOx emission combustor; and a gas turbine controller. The gas turbine controller is arranged and configured for regulating the combustion temperature according to at least one control parameters of the turbomachine so that a lean blowout of the combustor is prevented when a transient event involving the driven turbomachine occurs.

According to another aspect, a method for controlling combustion of a gas turbine engine drivingly connected to a driven turbomachine is disclosed. The gas turbine engine includes a dry low NOx emission combustor; and a gas turbine controller. Embodiments of the method disclosed herein comprise the step of regulating the combustion temperature according to at least one control parameters of the turbomachine so that a lean blowout of the combustor is prevented when a transient event involving the driven turbomachine occurs.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. An embodiment of the invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic gas turbine engine for mechanical drive in an LNG application;

FIG. 2 illustrates a sectional view of an exemplary compressor driven by the gas turbine engine;

FIGS. 3A to 3D illustrate details of a gas turbine engine combustors;

FIG. 4 illustrates a characteristic lean blowout curve of an ultra-low NOx emission combustor for use in a gas turbine engine according to the present disclosure;

FIG. 5 illustrates a flow chart of a method of controlling transient conditions in a gas turbine according to the subject matter disclosed herein.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

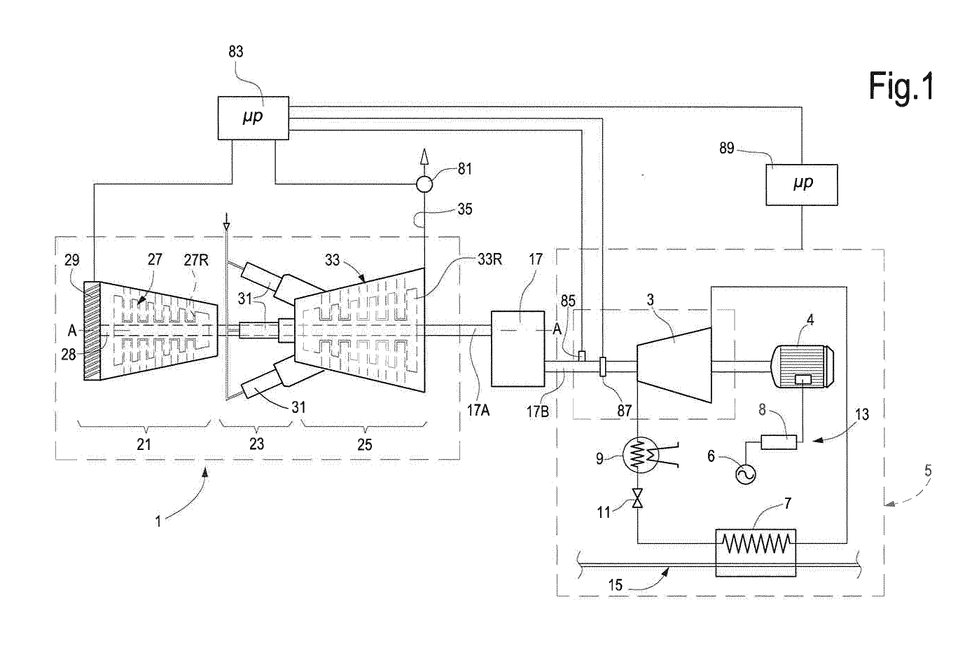

In FIG. 1 an exemplary gas turbine train in mechanical drive configuration is illustrated. The gas turbine train comprises a gas turbine engine 1 and a turbomachine 3 driven by the gas turbine engine 1. In the exemplary embodiment of FIG. 1 the driven turbomachine 3 comprises a gas compressor.

By way of non-limiting example, as a typical application, the gas compressor 3 forms part of a refrigerant cycle of an LNG plant, globally labeled 5. In some embodiments the suction side of the gas compressor 3 is fluidly coupled to a heat exchanger 7 and to the delivery side of gas compressor 3 is fluidly coupled to a condenser 9. The condenser 9 is in turn in fluid communication with an expansion device, such as an expansion valve 11 arranged between the condenser 9 and the heat exchanger 7 and in fluid communication therewith. A turboexpander can be used instead of an expansion valve 11, to recover mechanical power from the expansion of the refrigerant fluid circulating in the refrigeration cycle.

A loop globally labeled 13 is thus formed, including gas compressor 3, condenser 9, expansion valve 11, heat exchanger 7 and relevant piping fluidly connecting these loop components to one another. The fluid processed through the loop 38 is subjected to cyclic thermodynamic transformations to remove heat from natural gas flowing through a pipe 15.

The gas turbine engine 1 can be mechanically coupled to gas compressor 3 through a single shaft line, in which case the rotation speed of the gas compressor 3 is substantially the same as the rotational speed of the gas power output shaft. In other embodiments, as shown schematically in FIG. 1, a gearbox 17 with an inlet 17A and an outlet 17B is arranged between the gas turbine engine 1 and the gas compressor 3.

In some embodiment the gas turbine engine 1 can include a single-shaft gas turbine. In other embodiments, a multi-shaft gas turbine engine 1 can be provided.

The gas compressor 3 can further be mechanically coupled to an electric machine 4. The electric machine 4 can be connected to an electric power distribution grid 6. In some embodiments, a variable frequency driver 8 can be arranged between the electric power distribution grid 6 and the electric machine 4. The electric machine 4 can be a reversible electric machine capable of operating in an electric generator mode and in an electric motor mode (helper mode) respectively. The electric machine 4 can be switched to the electric generator mode if the mechanical power generated by the gas turbine engine 1 exceeds the power required to drive the gas compressor 3. Useful mechanical power available on the gas turbine shaft is then converted into electric power and delivered to the electric power distribution grid 6. Conversely, if the mechanical power generated by the gas turbine engine is insufficient to drive the gas compressor 3 at the required operating conditions, the electric machine 4 can be switched in the helper mode and generate additional mechanical power by converting electric power from the electric power distribution grid 6. The variable frequency driver 8 allows the non-synchronous operation of the electric machine 4, i.e. allows the electric machine 4 to rotate at a speed which can be different from (i.e. non-synchronous with) the grid frequency.

The gas turbine engine 1 can comprise an air compression section 21, a combustor section 23 and a turbine section 25. The air compression section 21 can be comprised of an air compressor 27, e.g. an axial compressor comprising a compressor rotor 27R supported by a rotating gas turbine shaft 28. The inlet of the air compressor 27 can be provided with variable inlet guide vanes (here below shortly kW) 29.

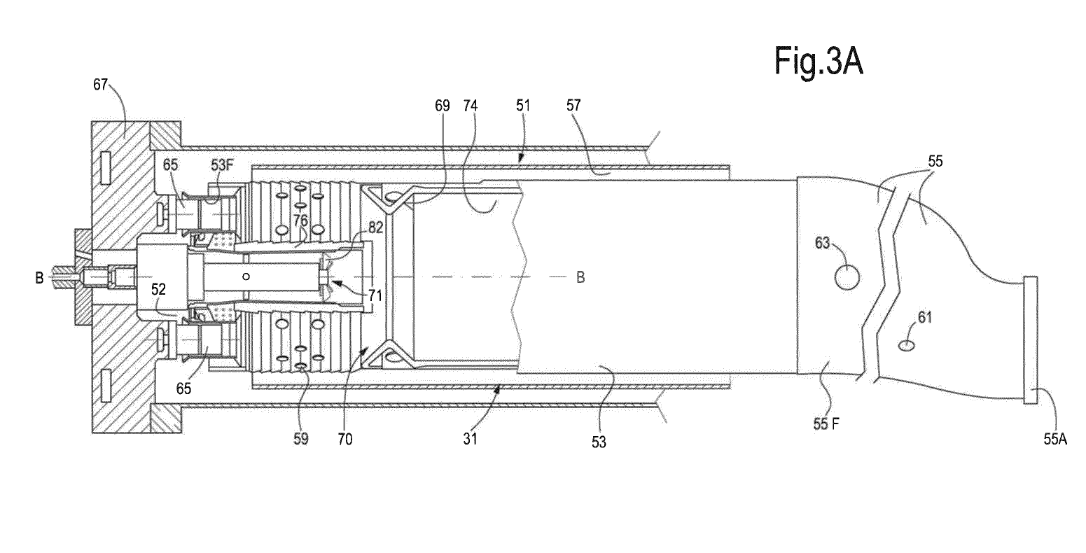

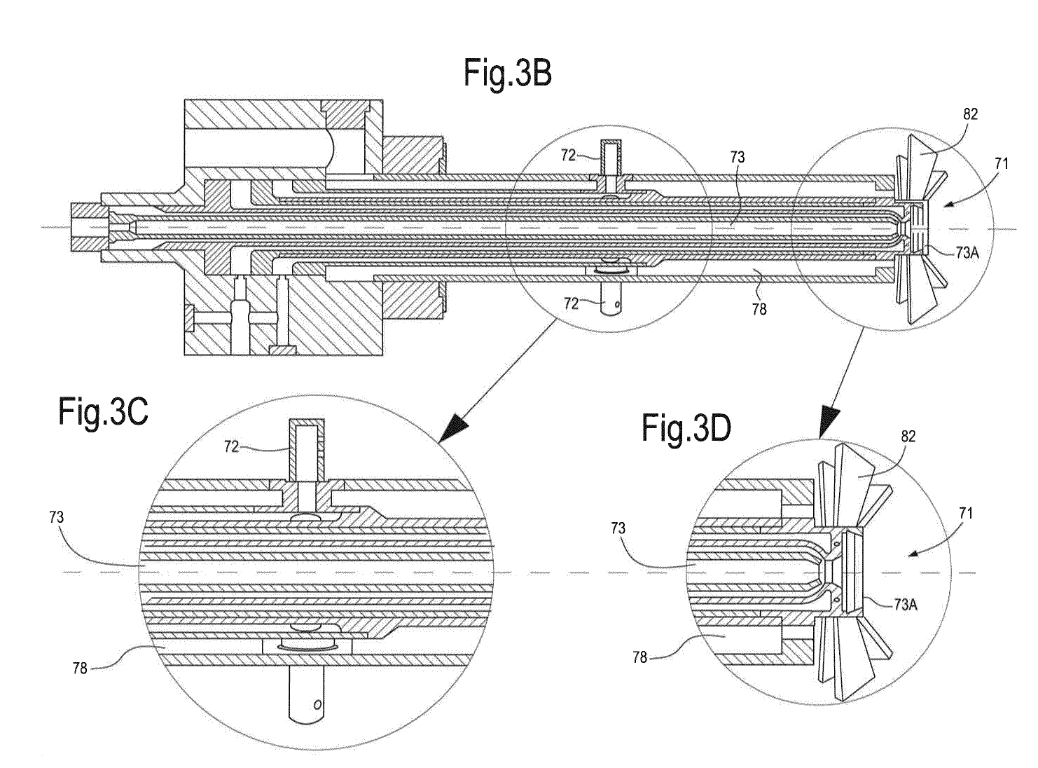

The combustor section 23 can be comprised of one or more combustors 31. Usually, a plurality of combustors 31 are located in an annular array about the axis A-A of the gas turbine. An exemplary embodiment of a combustor 31 will be described later on with reference to FIGS. 3A-3D. Fuel F, e.g. a fuel gas, is delivered to the combustors 31, where it is mixed with compressed air from the air compressor 27 and burned to generate combustion gases, which are expanded in a turbine 33 of the turbine section 25. The turbine 33 comprises a turbine rotor 33R, which can be supported on shaft 28 if the gas turbine engine 1 is of the single-shaft type. Exhaust combustion gases are discharged from the turbine 33 in an exhaust stack 35.

In the embodiment schematically shown in FIG. 1 the gas turbine engine is a single-shaft gas turbine engine, i.e. the compressor rotor 27R and the turbine rotor 33R are supported by one and the same shaft, at one end whereof a mechanical coupling is provided, for drivingly connecting the gas turbine engine 1 to the compressor 3. In other embodiments, not shown, the gas turbine engine 1 can have a multi-shaft configuration, including at least two turbine wheels, namely a high-pressure turbine wheel and a low-pressure turbine wheel. The high-pressure turbine wheel is mounted on the same shaft as the compressor rotor 27R for co-rotation therewith. The second turbine wheel is mounted on a second shaft, which is drivingly coupled to the gas compressor 3. Combustion gases are sequentially expanded in the high-pressure turbine wheel and in the low-pressure turbine wheel to generate first mechanical power to drive the air compressor 27 and additional mechanical power to drive the gas compressor 3. The two turbine wheels can rotate at different speeds.

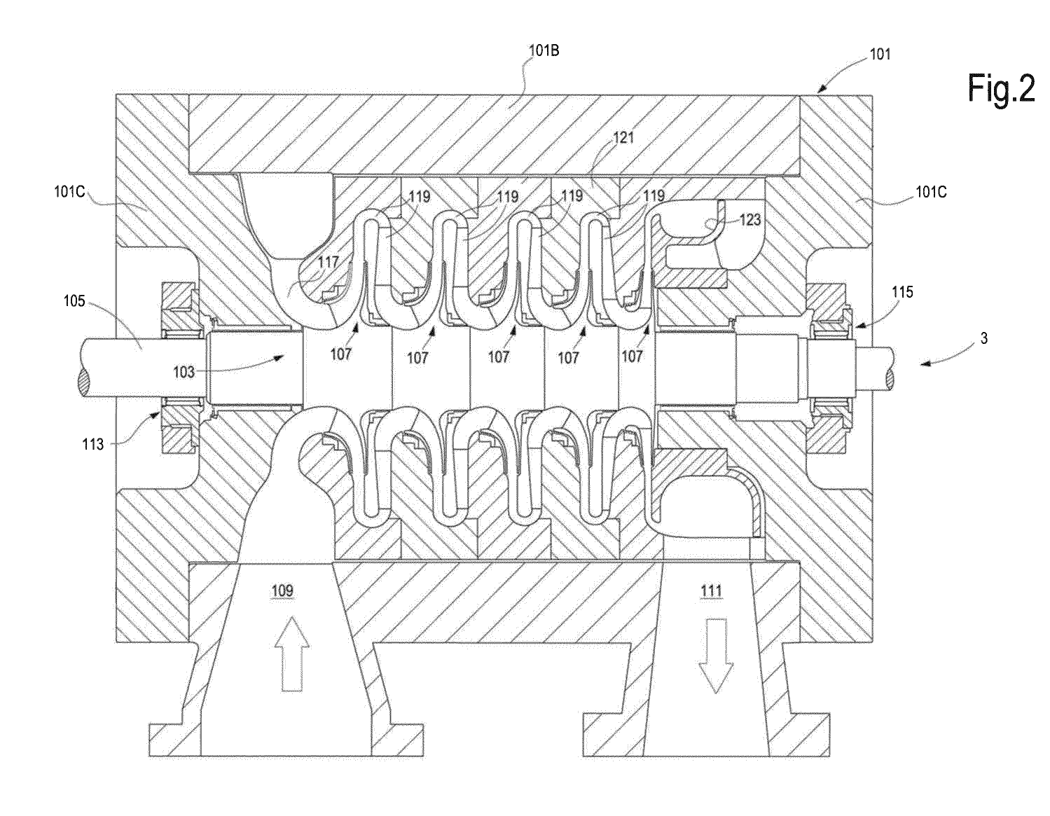

In an exemplary embodiment, as illustrated in FIG. 2 with continuing reference to FIG. 1, the gas compressor 3 can be comprised of an outer casing 101, wherein a rotor 103 is housed. The rotor 103 is comprised of a shaft 105 and a plurality of impellers 107. In the example shown in FIG. 2 the multistage centrifugal compressor 100 comprises five impellers sequentially arranged in a flow direction from a compressor inlet 109 to a compressor outlet 111. The shaft 105 is supported by bearings 113, 115. Each impeller forms part of a respective compressor stage which comprises an inlet channel 117 and a return channel 119. Gas processed by each impeller 107 enters the impeller at the inlet 117 and is returned by the return channel 119 towards the inlet 117 of the next impeller. The return channel of the various compressor stages are formed by one or more diaphragms 121, which are stationarily housed in the casing 101. The gas discharged from the last impeller, i.e. from the most downstream impeller, is collected by a volute 123, wherefrom the compressed gas is conveyed to the gas outlet 111. The casing 101 can be comprised of a barrel 101B and two end portions 101C, forming a closed housing where the rotor 103 is rotatingly arranged and the diaphragms 121 are stationarily housed. Mechanical power is used to rotate impellers 107 and is transformed into gas pressure, said pressure increasing gradually as the gas flows through the sequentially arranged impellers.

In an exemplary embodiment, as illustrated in FIGS. 3A-3D, with continuing reference to FIG. 1, each combustor 31 can include a combustor housing 51, wherein a liner or flame tube 53 is arranged. A transition piece or transition duct 55 connects an aft end 53A of the liner 53 to the inlet of turbine 33.

An annular flow passage 57 is formed between the outer surface of the liner 53 and the inner surface of the combustor housing 51. Compressed air flows in the annular flow passage 57 and enters the inner volume of liner 51 and transition piece 55 through a plurality of holes. In some embodiments a plurality of air inlet holes, referred to as mixing holes 59, are provided near a forward end 53F of the liner 53. Further air enters in the liner 51 through passages provided in an end plate 52 at the rear end of the liner. Additional holes, referred to as dilution holes 61 and 63 are located in the transition piece 55, near an aft end 55A and a forward end 55F thereof, respectively.

A plurality of primary fuel nozzles 65 are arranged around the axis B-B of the liner and supply fuel gas in the interior of liner 53. Under steady state operating conditions, fuel gas delivered by the primary fuel nozzles 65 is pre-mixed with compressed air entering the liner 53 through the mixing holes 59 and the air passages in the end plate 52. After ignition of the combustor 31, and once the steady state operating conditions of the gas turbine engine 1 have been achieved, the flame of the burning gas/air mixture will be located downstream of the mixing holes, and specifically downstream of a junction region, e.g. a Venturi throat region 69, formed in the interior of the liner 53. The Venturi throat region 69 divides the interior of the liner 53 into an upstream combustion chamber 70, also named primary zone, and a downstream combustion chamber 74, also named secondary zone. While in an initial ignition phase the flame will be located in the upstream combustion chamber 70 or primary zone, under steady, low-emission combustion conditions the flame will be located in the downstream combustion chamber 74 or secondary zone.

A secondary fuel nozzle 71 is arranged substantially coaxially to axis B-B of liner 53. The secondary fuel nozzle 71 can be mounted in a cap center body 50 of combustion liner 53 supported at the end plate 52 and is comprised of co-axial channels feeding different fuel gas lines. The central body 50 extends substantially coaxially to the liner in the upstream combustion chamber 70. According to some embodiments, fuel gas is driven through a plurality of secondary nozzle pegs 72 and a limited amount of fuel is provided to a secondary nozzle pilot tube 73 ending with a pilot tip 73A. The secondary nozzle pegs 72 provide fuel to a pre-mix reaction zone 76 of the combustor 31 formed in central body 50 of the combustion liner 53, while the pilot tube 73 provides fuel to the downstream combustion chamber 74 where it is immediately burned (diffusion combustion).

According to some embodiments, the secondary fuel nozzle 71 can further include a fuel transfer line 78 to provide additional fuel gas to be used during the transfer between different combustion modes of combustor 31.

Fuel gas delivered through secondary nozzle pegs 72 is pre-mixed with compressed air from the compressor section 21 in the pre-mix reaction zone 76 and the air-fuel mixture is injected through a swirler 82 into the downstream combustion chamber 74. The fuel delivered through pilot tube 73 and pilot tip 73A stabilizes the combustion through a diffusion flame.

The secondary nozzle pegs 72 and the secondary nozzle pilot tube 73 each have their own independent fuel piping circuit, each having independent and exclusive fuel sources. The fuel flow rate delivered to the secondary nozzle pilot tube 73 and through the secondary nozzle pilot tip 73A is less than about 2% of the total gas turbine fuel flow and, in one embodiment, is capable of delivering and controlling the fuel flow rate in the range of about 0.002 pps (pounds per second) to about 0.020 pps. Independent control of the two fuel introduction locations (secondary nozzle pegs 72 and secondary nozzle pilot tube 73) provides an additional degree of freedom which may be exercised to optimize the combustion system and minimize the CO and NOx emissions produced by the gas turbine system. In particular, the independent control of the two fuel introduction locations may achieve sub-5 ppm (parts per million) NOx emissions across the given ambient and load range. The fuel piping circuits and passages are described in greater in US 2007/0130955, the content whereof is incorporated herein by reference.

Under steady state conditions the gas turbine engine 1 described so far can be operated under ultra-low NOx emission control substantially as follows.

The fuel gas is partly fed to the primary fuel nozzles 65 and partly to the secondary fuel nozzle 71. In some embodiments around 80% of the fuel flow is delivered to the primary fuel nozzles 65 and the remaining 20% is delivered to the secondary fuel nozzle 71. The partition of the total gas fuel flow rate between primary fuel nozzles and secondary fuel nozzle is named “split”. The fuel gas flow through the secondary fuel nozzle 71 is in turn divided between the secondary nozzle pegs 72 and the secondary nozzle pilot tube 73. The lean air/fuel mixture burns in the downstream combustion chamber or secondary zone 74. Fuel delivered through the primary fuel nozzles 65 is pre-mixed with air in the primary zone 70 and the air/fuel mixture burns in the downstream combustion chamber or secondary zone 74.

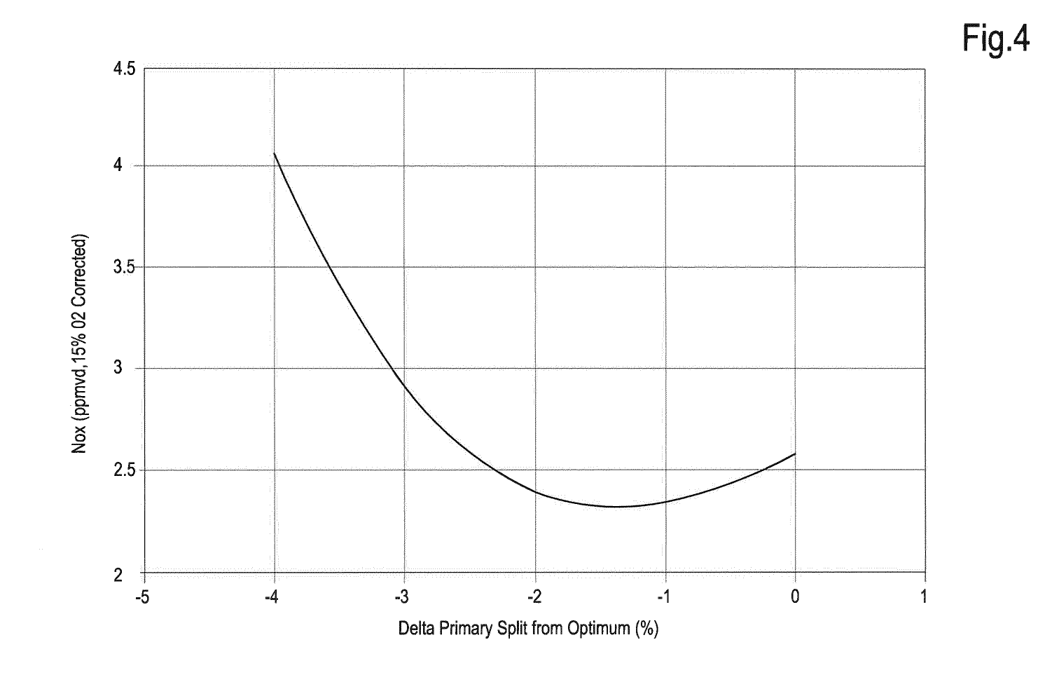

The fuel flow rate and the air flow rate under steady state operative conditions are set such as to operate the combustor under ultra-lean combustion conditions, which reduces noxious NOx emissions. However, ultra-lean combustion is extremely susceptible to thermo-acoustic instabilities and lean blowout, which can lead to extinction of the flame with consequent drawbacks in terms of plant shut down. To prevent or mitigate the risk of gas turbine engine shut down, the combustor is usually operated above a lean blowout (LBO) limit curve, which can be experimentally determined for a given combustor. FIG. 4 illustrates an exemplary LBO curve. On the horizontal axis the delta primary split ratio from optimum is plotted, the optimum split being defined as the fuel gas split setting between primary fuel nozzles 65 and secondary fuel nozzle 71, i.e. the ratio between the fuel gas delivered to the primary fuel nozzles 65 and the fuel gas delivered to the secondary fuel nozzle 71. NOx emission (expressed in ppm corrected to 15% O₂) is plotted on the vertical axis. The LBO curve represents the limit under which extinction of the flame in the combustion chamber occurs. The combustor set point shall therefore be selected such that a sufficient margin from the LBO curve is maintained.

In exemplary embodiments the set point can be selected at “optimum split −1%” with NOx target of approximately 3.5 ppm, corresponding to a LBO limit of approximately 2.5 ppm. The set point is characterized by a combustion reference temperature, which is achieved and maintained by a given fuel/air flowrate ratio.

As stated, in mechanical drive applications the operation of the gas turbine train is controlled by the turbomachine 3 driven by the gas turbine engine. In the exemplary embodiment of FIG. 1 the operating conditions of gas compressor 3 control the gas turbine engine 1. The gas compressor 3 can be subjected to frequent and fast transients due, for instance, to variations of the requests from the process whereof the gas compressor forms part. In the exemplary embodiment of FIG. 1, for instance, the rotation speed of gas compressor 3 and/or the load thereof can vary depending upon the actual operating conditions of the refrigeration cycle. From a full load condition, the gas compressor 3 may require to slow down to partial load or vice-versa. Or else the rotation speed of the gas compressor 3 can be required to change from full speed to partial speed or vice-versa.

If the gas turbine engine 1 is operating under ultra-low NOx emissions, the sudden variation of compressor speed or load required by the cycle may cause the combustor operation point to move towards the LBO curve. For instance, if the rotation speed or the load of gas compressor 3 drops, less fuel is required. However, a reduction in the fuel flow rate will cause a drop in the fuel/air flowrate ratio, due to the inertia of the air compressor 27 of the gas turbine engine, and consequent risk of flame extinction or lean blowout.

To prevent lean blowout, the combustor can be monitored during transient events and actions can be taken by the gas turbine engine controller during transients.

According to some embodiments, the actual combustion temperature can be monitored and compared with a combustion reference temperature. If the difference between the monitored combustion temperature and the combustion reference temperature exceeds a threshold, e.g. due to a transient in the operating conditions of the gas compressor 3, action is taken by a gas turbine controller 83 to prevent lean blowout.

The actual combustion temperature can be calculated starting from the exhaust temperature. A temperature sensor 81 can be provided at the GT exhaust 35 and provides a temperature measurement to the gas turbine controller 83. Calculation of the combustion temperature from the exhaust temperature can be performed in a known manner.

In order to prevent lean blowout, transient events can be managed by means of event-based actions. An event-based action can be any action, which is active during transient operation of the gas compressor 3 and inactive during steady state operation. Typical transient events can be the transition from a base-load operating condition to peak operating condition of gas compressor 3 or vice-versa. The gas turbine controller 83 can be configured to receive input information on one or more operating parameters of the gas compressor 3 and/or of the plant 5, whereof the gas compressor 3 forms part. The parameters can be indicative of a transient event. In some embodiments, a speed sensor 85 and/or a torque sensor 87 can be provided for measuring the rotation speed of the rotation speed of the gas compressor 3 or the torque applied to the shaft of compressor 3. In some embodiments, a compressor controller and/or a process controller 89 can be provided, which controls the gas compressor 3 or the process, whereof the gas compressor 3 forms part. Information on occurring or incoming transient events can be provided by compressor controller or process controller 89 to the gas turbine controller 83.

Irrespective of how information on a transient event is generated, information on the transient event causes the gas turbine controller 83 to activate an event-based action which is aimed at preventing combustion issues, in particular lean blowout.

An event-based action can involve a faster control of the fuel valves, aimed at changing the split, i.e. the ratio between fuel gas flow rate delivered to the primary fuel nozzles 65 and to the secondary fuel nozzle 71, respectively, to better anchor the flame and keep a stable and robust combustion during transient events. In some events, during transient the split between primary fuel nozzles 65 and secondary fuel nozzle 71 can be temporarily modified by increasing the amount of fuel to the secondary nozzle 71 with respect to the amount of fuel to the primary nozzles 65

The combustion temperature and the NOx emissions will temporarily increase, moving away from the LBO curve, which prevents the risk of lean blowout during the transient.

A further event-based action can involve the operation of the variable IGV 29. A low gain to open IGV and a fast gain to close IGV will increase the combustion temperature during the transient event or combustion stability to safely keep the combustor stability and prevent lean blowout.

Another type of event based action acts directly on the emission implemented in the control software. An emission model predicts the gas turbine emission and sets through the controller the turbine operating parameters in order to achieve the predicted target emission. In case of a transient event the emission model is modified using an inflation factor that offsets the operating point of the turbine causing the unit to operate further away from operational boundaries.

The event-based action can cease upon ending of the transient event, such that the combustor will return to an ultra-low-emission operating condition.

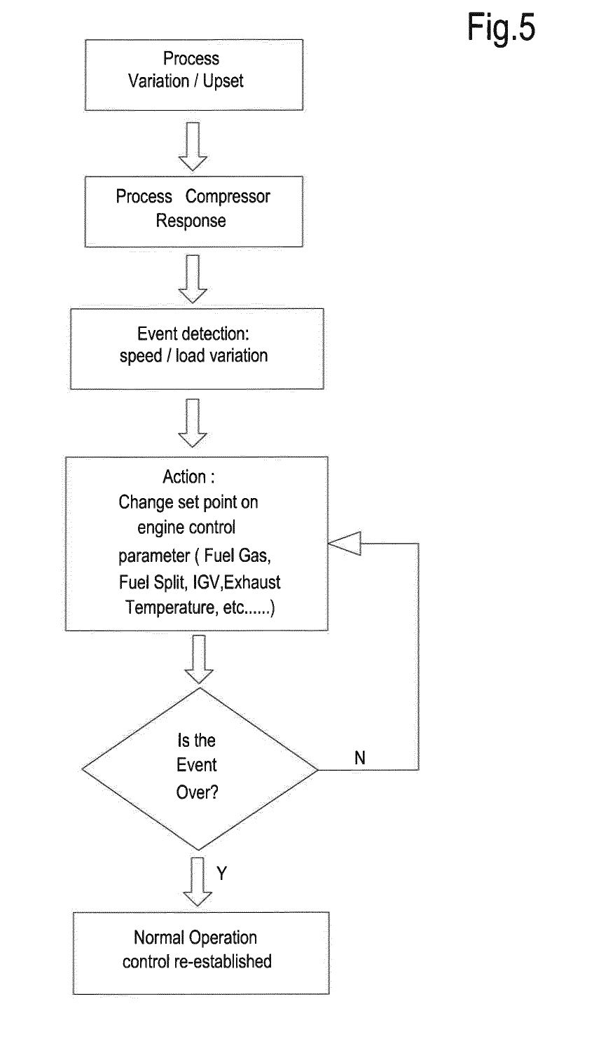

FIG. 5 illustrates a flow chart summarizing the above described event-based action triggered by a transient occurring in the operation of gas compressor 3.

Transient events triggering an event-based action can involve a variation of the speed and/or of the load of the driven turbomachine. For instance, a load variation equal to or higher than 10% can trigger the event-based action. Faster occurring events can be more critical. In some embodiments, event-based actions can be triggered e.g. if the load variation is equal to or higher than 8% per minute with respect to a rated load. In some embodiments of the methods disclosed herein, event-based actions can be triggered also by smaller and/or slower load transients, if the load transient causes a significant variation of the rotary speed, for instance equal to or higher than 1%.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A gas turbine drive system in mechanical drive configuration, the system comprising: a gas turbine engine drivingly connected to a driven turbomachine, the gas turbine engine including a dry low NOx emission combustor; and a gas turbine controller; wherein the gas turbine controller is arranged and configured for regulating the combustion temperature according to at least one control parameters of the turbomachine so that a lean blowout of the combustor is prevented when a transient event involving the driven turbomachine occurs; the transient event being a change in rotation speed of the driven turbomachine.

2. The system of claim 1, wherein the transient event further comprises one of:
a change in load of the driven turbomachine, a change in a temperature of the gas turbine discharge, and fuel stroke reference.

3. The system of claim 1, wherein the transient event occurs when the load varies by 10% or more.

4. The system of claim 1, wherein the transient event occurs when the load varies by 8% per minute or faster.

5. The system of claim 1, wherein the transient event occurs when a load variation causes a speed variation of 1% or more of the driven turbomachine.

6. The system of claim 1, wherein the ultra-low dry low NOx emission combustor comprises a plurality of combustors located in an annular array about the axis of the gas turbine; wherein each combustor comprises:
an upstream combustion chamber and a downstream combustion chamber in fluid communication with one another at a junction region;
a plurality of primary fuel nozzles arranged for providing fuel to the upstream combustion chamber; the upstream combustion chamber comprising a mixing hole arrangement for improving homogeneity of an air and fuel mixture in the upstream combustion chamber;
a secondary fuel nozzle arranged for providing fuel to the downstream combustion chamber;
a transition piece fluidly connecting the downstream combustion chamber to an inlet of a turbine section of the gas turbine engine.

7. The system of claim 6, wherein the junction region comprises a Venturi throat.

8. The system of claim 6, wherein the secondary fuel nozzle comprises an elongated body, along which a secondary nozzle pilot tube extends, said secondary nozzle pilot tube ending at a pilot tip; and wherein secondary nozzle pegs are arranged in an intermediate position along the elongated body; fuel gas being delivered separately to the secondary nozzle pilot tube and to the secondary nozzle pegs.

9. The system of claim 8, wherein the secondary fuel nozzle is located in a central body extending in the upstream combustion chamber.

10. The system of claim 9, wherein the elongated body of the secondary fuel nozzle extends substantially coaxially to the central body and wherein the secondary nozzle pegs are configured and arranged for delivering fuel gas in a pre-mix reaction zone in the central body surrounding the secondary fuel nozzle, said pre-mix reaction zone being in fluid communication with an outlet end of the central body, wherefrom a fuel/air mixture formed in the pre-mix reaction zone flows into the downstream combustion chamber.

11. The system of claim 10 wherein a swirler arrangement is located between the pre-mix reaction zone and the outlet of the central body.

12. The system of claim 7, wherein the upstream combustion chamber is configured so that during nominal operation the fuel provided by the primary nozzles is fully premixed with air provided in the upstream combustion chamber and the air/fuel mixture is delivered to the downstream combustion chamber for combustion with reduced emissions of NOx and CO.

13. The system of claim 12, wherein the gas turbine controller is configured and arranged for triggering an event-based action when said transient event involving the driven turbomachine occurs.

14. The system of claim 13, wherein said event-based action is selected from the group consisting of: a faster control of the fuel valves; a change in a ratio between fuel rate to primary fuel nozzles and fuel rate to secondary fuel nozzle of said combustor; and an operation on variable IGV of the gas turbine engine.

15. A method for controlling a combustion of a gas turbine engine drivingly connected to a driven turbomachine, the gas turbine engine including a dry low NOx emission combustor; and a gas turbine controller (83), the method comprising the step of regulating the combustion temperature according to at least one control parameters of the turbomachine so that a lean blowout of the combustor is prevented when a transient event involving the driven turbomachine occurs, the transient event being a change in rotation speed of the driven turbomachine.

16. The method of claim 15, further comprising the step of triggering an event-based action when said transient event involving the driven turbomachine occurs.

17. The method of claim 16, wherein said event-based action is selected from the group consisting of: a faster control of the fuel valves; a change in a ratio between fuel rate to primary fuel nozzles and fuel rate to secondary fuel nozzle of said combustor; and an operation on variable IGV of the gas turbine engine.
